(19) United States
(12) Patent Application Publication
(10) Pub. No.: US 2017/0001832 A1
(43) Pub. Date: Jan. 5, 2017

(54) BRAKE FORCE MONITORING OF AN ELEVATOR BRAKE

(71) Applicant: INVENTIO AG, Hergiswil (CH)

(72) Inventors: Bjarne LINDBERG, Adligenswil (CH); Guntram BEGLE, Weggis (CH); Josef VERTESY, Luzern (CH)

(21) Appl. No.: 15/039,915

(22) PCT Filed: Dec. 9, 2014
(86) PCT No.: PCT/EP2014/076985

§ 371 Date: May 27, 2016

(30) Foreign Application Priority Data
Dec. 9, 2013 (EP) 13196223.5

(51) Int. Cl. B66B 5/00; B66D 5/30; B66D 5/08

(52) U.S. Cl. CPC B66B 5/0031; B66D 5/08; B66D 5/30

(57) ABSTRACT

A method and apparatus for monitoring an elevator drive brake wherein the method includes the steps of detecting a spring force (F_{s-closed}) when the brake is closed, detecting a spring force (Fₛ₋ₒₚₑₙ) when the brake is open, determining the difference between the two detected spring forces (ΔFₛ), and comparing the difference between the two detected spring forces with at least one preset permissible force differential (ΔFₛₘᵢₙ; ΔFₛₘₐₓ) to determine whether the brake is defective. The apparatus includes a force sensor for each brake spring to be monitored, and an electronic monitor that stores at least one preset permissible force differential (ΔFₛₘᵢₙ; ΔFₛₘₐₓ) and, during operation, compares the at least one preset permissible force differential with an actual force difference (ΔFₛ) between an open spring force (Fₛ₋ₒₚₑₙ) and a closed spring force (F_{s-closed}) as detected by the force sensor.

### FIELD

The present disclosure relates to elevators and particularly to a method and apparatus for monitoring spring force within a brake system mounted in conjunction with an elevator motor. Although, the apparatus can be provided preassembled together with the brake system and motor as a drive for newly planned installations, it is envisaged that the apparatus is particularly beneficial when supplied as a kit for modernizing existing installations.

### BACKGROUND

A brake is normally provided to halt rotation of the motor in traction elevators. The brake includes a brake drum either mounted directly on an output shaft of the motor or, alternatively, indirectly connected thereto via a gear. At least one pivotal brake arm having a brake lining is biased by a compressed spring towards the drum so that when the brake closes the lining frictionally engages with a brake surface on the drum to halt the motor. An actuator, typically electromagnetically, hydraulically or pneumatically driven, is provided to act on the brake arm to open the brake by further compressing the spring to overcome the spring bias and move the arm and lining away from the drum. Consequently, in the open brake position, the spring force acting on the brake arm is greater than in the closed brake position.

Conventionally, one or more brake contacts monitor the position of the brake arm to determine whether the brake is open or closed so as to prevent the motor from starting when the brake is closed.

As explained above, in the open brake position, the spring is further compressed by the actuator and therefore the spring force acting on the brake arm is substantially greater than in the closed brake position. A system is described in JPH-A-0672672 which utilizes this phenomenon. Instead of brake contacts, load cells are positioned at the end of the springs to measure the actual spring force and thereby determine whether the brake is closed and open.

A further system is outlined in WO-A1-2011/098850 which again uses load cells but not to determine whether the brake is open or closed as in JPH-A-0672672, but instead to measure the actual spring force when the brake is closed to detect whether the brake lining is worn out. The brake lining is a sacrificial component of the brake which gradually erodes and as the lining erodes, the spring force when the brake is closed decreases. Accordingly, if the actual spring force monitored by the load cells during braking (closed brake) is not within predefined force limits or boundaries a signal is output to the elevator controller which can be subsequently used to take the effected elevator out of operation and/or inform a remote monitoring center that the brake needs service.

It will be appreciated that the elevator drive, whether installed within an elevator hoistway or in its own dedicated machine room located above, beside or below the hoistway, can be exposed to dramatic temperature variations throughout the course of a year. The brake drum is particularly susceptible to these variations. A conservative estimate is that a temperature increase of 50° C., which results in expansion of the drum, will reduce the air gap between the brake lining and the drum with the brake in its open position by around 30%. Accordingly, in high temperature conditions, the brake, although being detected as being open with the system outlined in JPH-A-0672672, might actually be closed. This gives rise to a condition known as dragging where the elevator travels with a closed brake. There are obvious disadvantages to dragging most notably excessive wear of the braking components particularly the brake linings, substantial increase in mechanical and electrical stress imposed upon the motor and a drastic reduction in overall energy efficiency.

The system of WO-A1-2011/098850 only monitors the actual spring force with the brake in the closed position so as to detect when the lining has worn out. Accordingly, the system will eventually detect dragging but only after the lining has worn out which, as mentioned above, is a direct result of the continuous elevator dragging.

Furthermore, both systems outlined above rely on a comparison of an initially stored reference value with the actual spring forces measured by the load cells. All force sensors, no matter what they are made of, how expensive or accurate they are, are susceptible to sensor drift over time. Sensor drift is a gradual degradation of the sensor that can make readings offset from the original calibrated state. Accordingly, with the systems described above it will be necessary to routinely recalibrate the load cells to correct for drift to ensure that the load cells are providing accurate spring force readings.

### SUMMARY

The invention provides a method and apparatus for monitoring an elevator drive brake. The method comprises the steps of detecting a spring force when the brake is closed, detecting a spring force when the brake is open, determining the difference between the two detected spring forces, and comparing the difference between the two detected spring forces with at least one preset permissible force differential to determine whether the brake is defective. The apparatus comprises a force sensor for each brake spring to be monitored, and an electronic monitor that stores at least one preset permissible force differential and, during operation, compares the at least one preset permissible force differential with an actual force difference between an open spring force and a closed spring force as detected by the force sensor.

Since the system compares force differences rather than actual force values then the effect of sensor drift is substantially eliminated.

The preset permissible force differential can be a minimum force differential such that the brake is determined to be defective if the difference between the two detected spring forces is less than or equal to the minimum force differential. With this arrangement brake dragging, broken brake springs and problems associated with the actuator can be detected.

Alternatively or additionally, the preset permissible force differential can be a maximum force differential such that the brake is determined to be defective if the difference between the two detected spring forces is greater than or equal to maximum force differential. This is an effective way of determining that the brake lining has worn excessively.

Preferably, an elevator safety chain is opened if the brake is defective. The safety chain may be opened immediately if the elevator is not travelling or, alternatively, only after the elevator has completed its current travel so as to allow any passengers travelling in the elevator to disembark.

Every time the brake is closed and opened, the detected spring force can be stored. Typically, the spring force is continuously detected while the brake is closed or open and the last value detected is stored as the detected spring force. This procedure further helps to mitigate the effects of sensor drift.

Accordingly, each time the brake is opened the actual open spring force can easily be compared with the stored closed brake force to determine the difference between the two spring forces. Naturally, the contrary procedure can be performed each time the brake is closed.

It is possible to detect whether the brake shall be open or closed by detecting whether the brake actuator has been energized. A convenient way to achieve this is by monitoring the voltage supplied to the brake actuator.

If the brake is defective, the difference between the open and closed spring forces can be stored and subsequently accessed by or displayed to a maintenance technician to enable him to gauge the nature of the brake defect. If the difference is less than or equal to the minimum force differential, the technician can check for brake dragging, broken brake springs or problems associated with the actuator. If the difference is greater than or equal to the maximum force differential, this will indicate to the technician that the brake lining has worn excessively.

Preferably commissioning is achieved by adjusting the brake, closing the brake, detecting and storing a closed spring force, opening the brake, recording and storing an open spring force, determining the difference between the open spring force and the closed spring force, and calculating and storing at least one preset permissible force differential from the determined difference between the open spring force and the closed spring force. The preset permissible force differential can be a minimum force differential which is calculated by multiplying the difference between the open spring force and the closed spring force by a factor of less than one, preferably less than 0.75. The preset permissible force differential can be a maximum force differential which is calculated by multiplying the difference between the open spring force and the closed spring force by a factor greater than one but preferably less than 1.1.

The system may be self-checking so that it can automatically determine whether power is available and whether force sensors are functioning. If either of these two determinations are negative, the elevator safety circuit can be opened and the elevator taken out of operation. Furthermore determinations can be made as to whether a voltage sensor is functioning and whether elevator is in travel such that the elevator safety circuit is opened if both determinations are negative.

The apparatus can be supplied as a kit for modernizing existing elevator installations or for subassembly in the factory with the drive for a new installation.

The apparatus may include a sensor to detect energization of the brake actuator and thereby determine whether the brake is open or closed.

Preferably, the apparatus can be interconnected to an elevator safety chain to interrupt the safety chain if a brake defect is detected. It can be interconnected directly to the safety chain or, alternatively, indirectly connected via an elevator controller.

The invention also provided an elevator installation including the brake force monitoring apparatus, a motor, and a brake with at least one spring biasing the brake into its closed position.

### DESCRIPTION OF THE DRAWINGS

The disclosure refers to the following figures:

FIG. 1 is a schematic plan view of an electromagnetically actuated prior art elevator brake depicted in its closed position;

FIG. 2 is a further schematic plan view of the electromagnetically actuated prior art elevator brake of FIG. 1 in its open position;

FIG. 3 is a detailed cross sectional view of the left brake spring of FIGS. 1 and 2;

FIG. 4 depicts the components of a brake force monitoring kit according to the invention;

FIG. 5 illustrates the left hand brake spring of FIG. 3 modified with a force sensor from the kit of FIG. 4;

FIG. 6 is a schematic depicting the arrangement of the kit of FIG. 4 installed in association with the brake of FIGS. 1 and 2;

FIG. 7 is a flowchart illustrating the commissioning of the brake force monitor shown in FIG. 6;

FIG. 8 is a further flowchart illustrating a self-check undergone by the brake force monitor shown in FIG. 6; and

FIG. 9 is a further flowchart illustrating the monitoring undertaken by the brake force monitor shown of FIG. 6.

### DETAILED DESCRIPTION

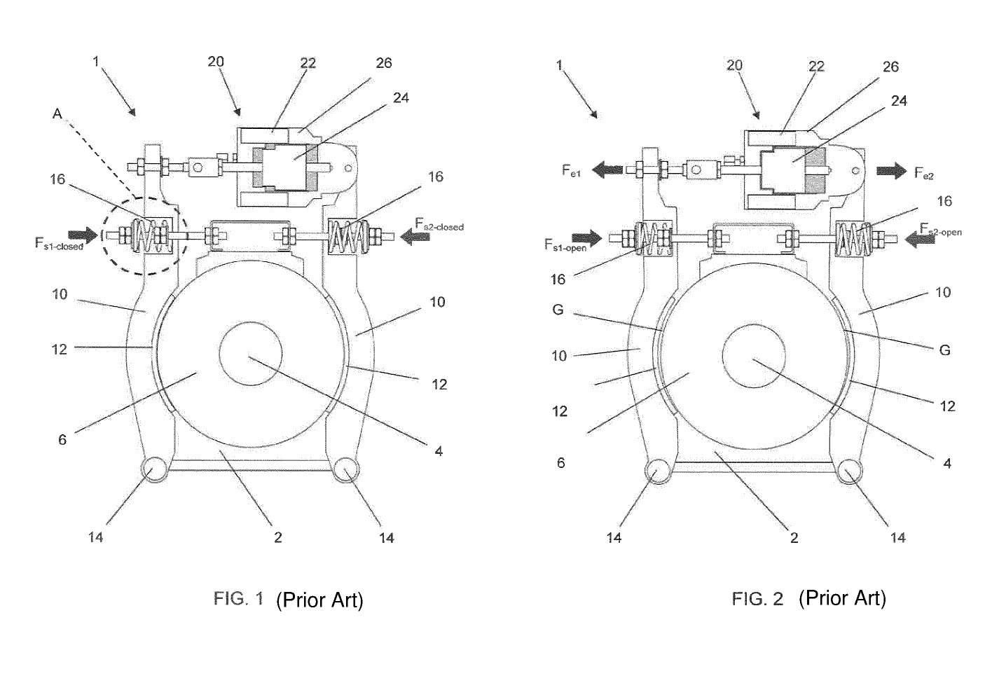

FIGS. 1 and 2 are schematic plan views of the same prior art elevator brake 1. Whereas FIG. 1 depicts the brake 1 in its closed position, FIG. 2 shows the brake 1 in its open position. The brake 1 includes a brake drum 6 either mounted directly on a shaft 4 either directly connected to a motor or, alternatively, indirectly connected thereto via a gear. Two brake arms 10 are provided at opposing sides of the drum 6 and are mounted at their lower ends on pivots 14 connected to a housing 2 of either the motor or the gear. Each arm 10 is fitted with a brake lining 12 and is biased by a pre-tensioned compression spring 16 towards the drum 6. The forces imposed on the brake arms 10 by the springs 16 are illustrated by the arrows Fₛ₁ and Fₛ₂, respectively. An electromagnetic actuator 20 is provided between and interconnects the upper ends of the brake arms 10. The actuator 20 includes a housing 26 containing a series of solenoid coils 22 and a movable solenoid plunger 24 extending from the housing 26.

In the closed position of the brake 1 as depicted in FIG. 1, the electromagnetic actuator 20 is de-energized and therefore unable to resist the inward biasing forces Fₛ₁ and Fₛ₂ of the brake springs 16 on the arms 10. Accordingly, the brake linings 12 frictionally engage with a brake surface on the drum 6 to either halt rotation of the shaft 4 or retain the shaft 4 in a stationary position.

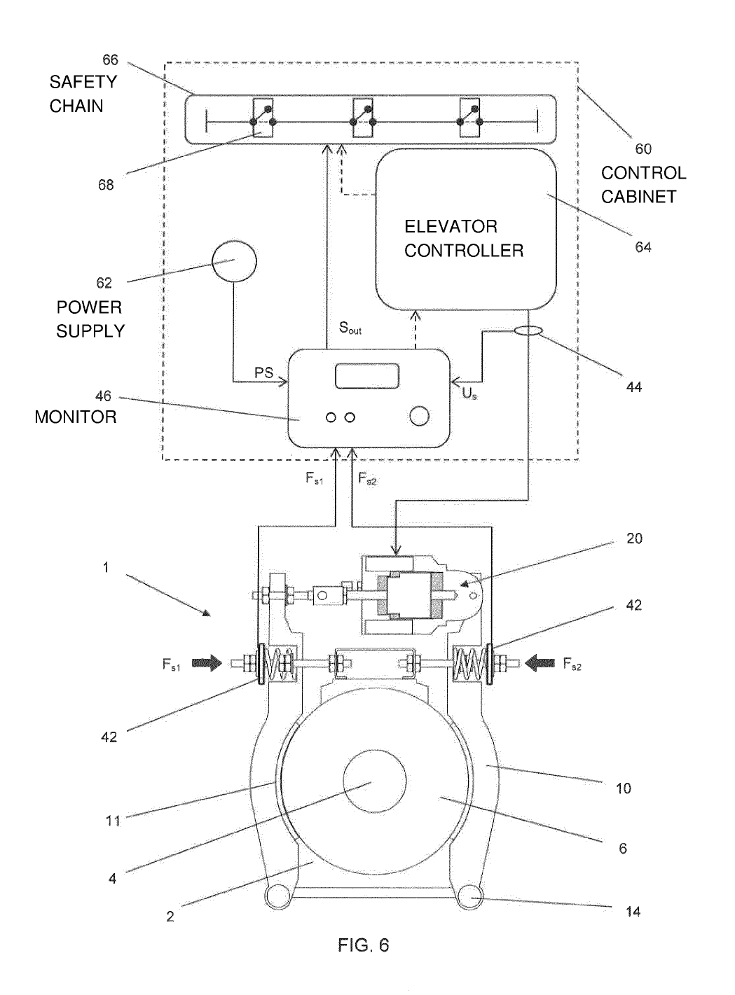

As shown in FIG. 2, when the electromagnetic actuator 20 is activated or energized, as instructed by an elevator controller 64 (see FIG. 6), current flows through the solenoid coils 22 which results in the further extension of the solenoid plunger 24 from the housing 26. This provides electromagnet opening forces illustrated by the arrows Fₑ₁ and Fₑ₂, respectively, acting on the opposing brake arms 10. The electromagnet opening forces Fₑ₁ and Fₑ₂ open the brake by further compressing the springs 16 to overcome the spring bias Fₛ₁ and Fₛ₂ and move the arms 10 and linings 12 away from the drum 6 resulting in the provision of an air gap G between the brake linings 12 and the drum 6.

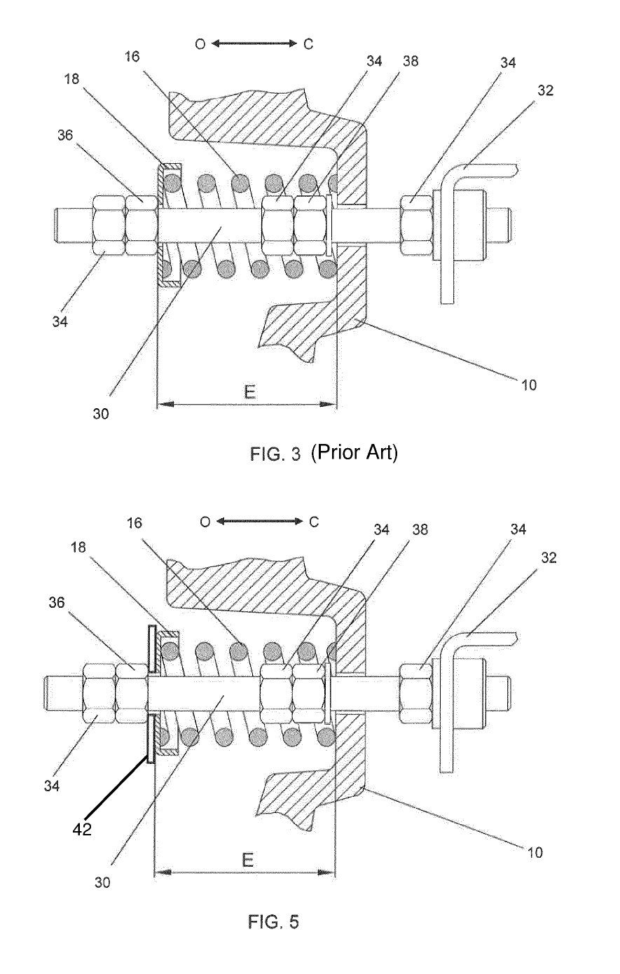

A cross section of the left brake spring 16, as indicated by the reference numeral A in FIG. 1, is illustrated in FIG. 3. A threaded rod 30 is secured at one end by a lock nut 34 to a bracket 32 mounted to the motor or gear housing 2 (as shown in FIGS. 1 and 2). The rod 30 extends from the bracket 32 through a hole provided in the brake arm 10. The pre-tensioned compression spring 16 is mounted over the threaded rod 30 between the brake arm 10 and spring endplate or retainer 18. An adjustment nut 36 and associated lock nut 34 are screwed onto the end of the rod 30 for engagement with the spring retainer 18. Accordingly, the position of the spring retainer 18 along the rod 30, and thereby the compression E of the spring 16, can be modified or fine-tuned by careful adjustment of the adjustment nut 36 and associated lock nut 34 along the threaded rod 30.

When the brake 1 is opened by the electromagnetic actuator 20, the brake arm 10 is moved under the influence of the electromagnet opening force Fₑ₁ in the opening direction O to further compress the spring 16. The extent to which the arm 10 can move in the opening direction O is limited by a washer and associated stop nut 38 provided on the rod 30.

On the contrary, when the electromagnetic actuator 20 de-energized, the biasing force Fₛ₁ of the pre-tensioned compression spring 16 moves the brake arm 10 in the closing direction C.

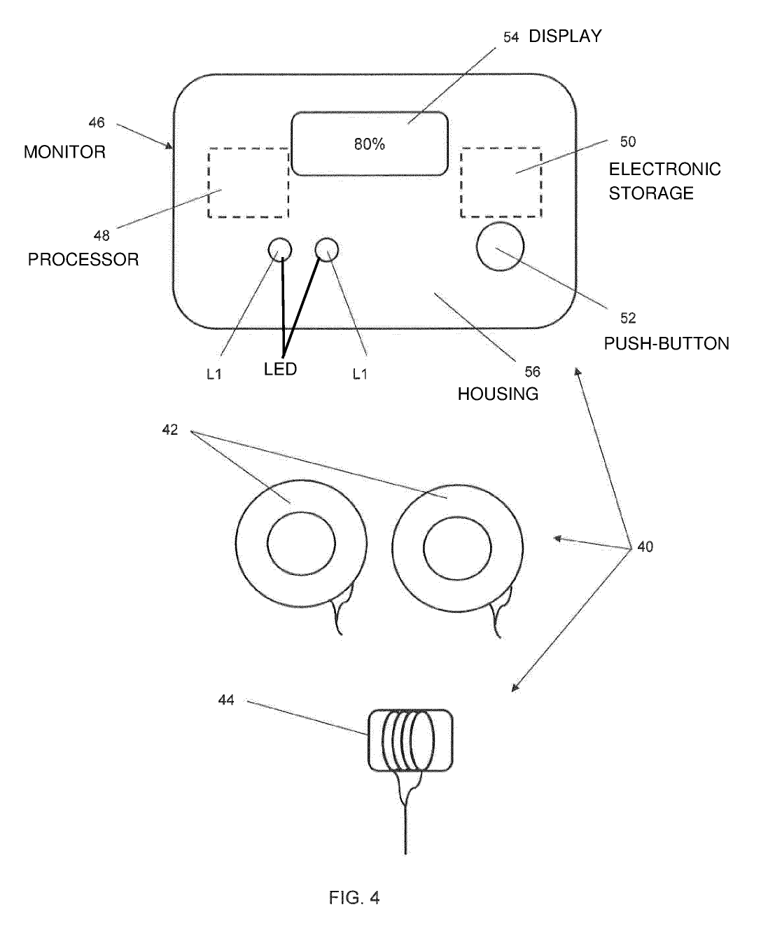

The main components of a brake force monitoring kit 40 according to the invention are shown in FIG. 4. A force sensor 42 for each brake spring 16 to be monitored is provided with the kit 40. In the present example, two such force sensors 42 are included to monitor the two opposing springs 16 of the brake 1 illustrated in FIGS. 1 to 3. Each force sensor 42 is disc shaped, may incorporate the functionality of the spring retainer or endplate 18 and may incorporate a strain gauge or may comprise a load cell as previously discussed with reference to the prior art.

A sensor 44 is provided to detect whether the electromagnetic actuator 20 is being supplied with electrical power from the elevator controller 64. In the present embodiment the sensor 44 is a voltage sensor. It will be appreciated that each electromagnetic actuator 20 used for elevator brakes 1 has specific characteristics and in particular a unique electrical profile. For example, as the voltage supplied to the actuator 20 increases, there will be a specific minimum opening voltage Uₒ at which the brake 1 opens fully. Conversely, as the voltage is withdrawn from the actuator 20, there will be a maximum closing voltage U_{c} at which the brake 1 closes. By comparing the actual voltage signal Uₛ with the preset maximum closing voltage U_{c}, it is possible to determine whether the brake 1 is closed or open.

Finally, the kit 40 includes an electronic monitor 46 comprising a housing or enclosure 56 protecting a processor 48 and electronic storage 50 mounted on an internal printed circuit board. Externally, the monitor 46 includes a manual push-button 52, an optional display 54, two LEDs L1 and L2, and multiple signal inputs and outputs (not shown).

The first stage in installing the brake force monitoring kit 40 is to mount each of the force sensors 42 between the spring retainer 18 and the associated adjustment nut 36 as illustrated in FIG. 5. It will be appreciated that instead of using separate force sensors 42, the force sensors can be integrated into new spring retainers 18.

Preferably, as depicted in FIG. 6, the electronic monitor 46 is mounted within an elevator control cabinet 60, since the control cabinet 60 normally provides an appropriate power supply 62 as well as access to the elevator safety circuit or chain 66. The voltage sensor 44 is positioned to detect whether the electromagnetic actuator 20 is being supplied with electrical power from the elevator controller 64. A signal Uₛ from the voltage sensor 44, a power supply PS and signals indicative of the biasing forces Fₛ₁ and Fₛ₂ of the springs 16 are fed into the monitor 46. As an output, the monitor 46 can provide a signal Sₒᵤₜ to stop the elevator by opening a safety contact or relay 68 within the safety chain 66.

In this example where the brake force monitoring kit 40 is being used to modernize an existing elevator brake 1 it is difficult, if not impossible, to easily access or modify the existing controller 64 to accept a signal from the monitor 46. For this reason the output signal Sₒᵤₜ from the monitor 46 is used to open a safety relay 68 within the safety chain 66 directly. The controller 64, in any case, will monitor the safety chain 66 and will take the elevator out of operation if the safety chain 66 is open.

However, it will be appreciated that in a new installation, without the design restrictions of modernization, the monitor 46 can be incorporated within or associated with the new controller 64 and the output signal Sₒᵤₜ from the monitor 46 can be used by the controller 64 to switch the safety chain 66, as indicated by the dashed lines in FIG. 6.

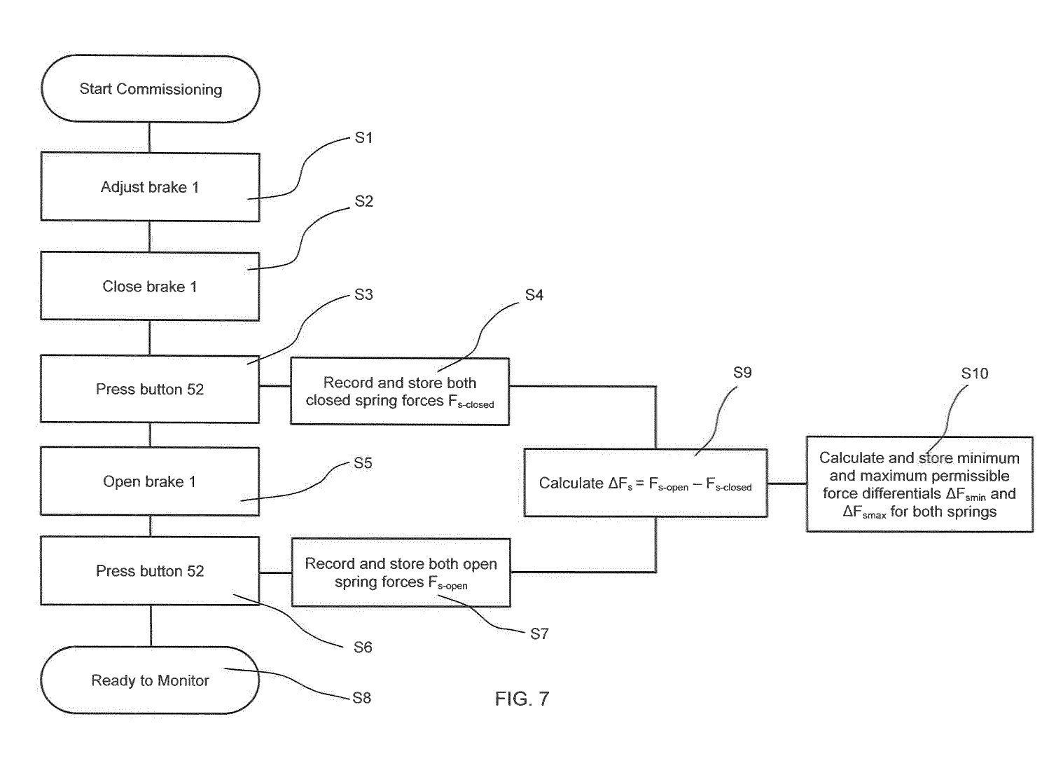

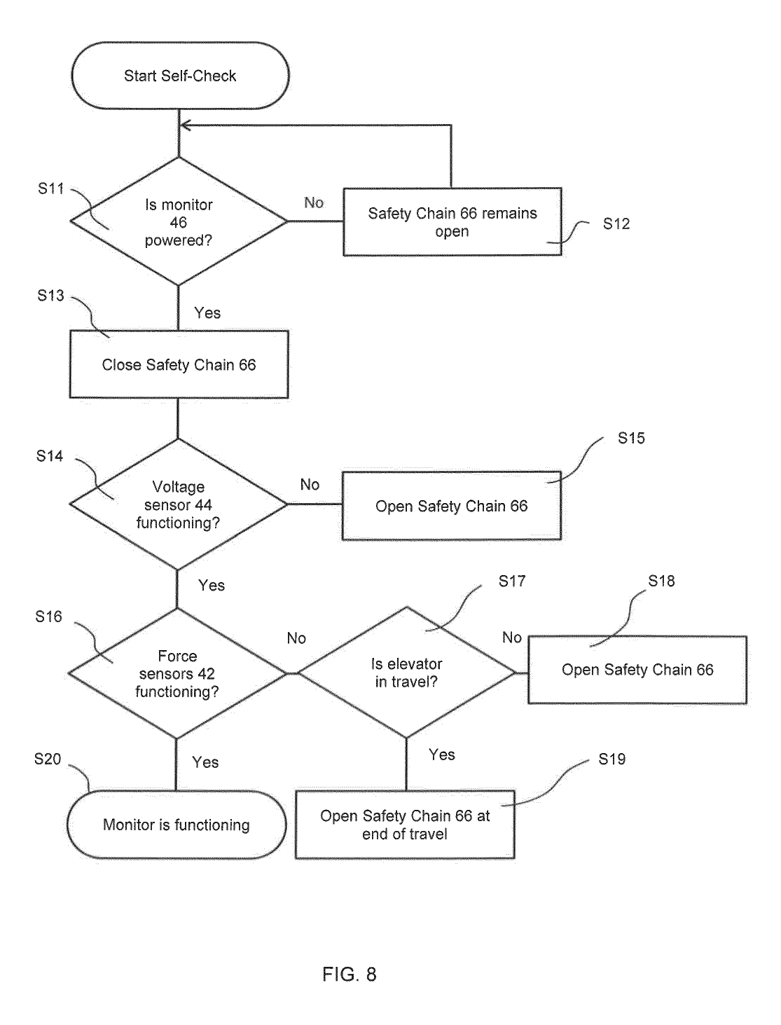

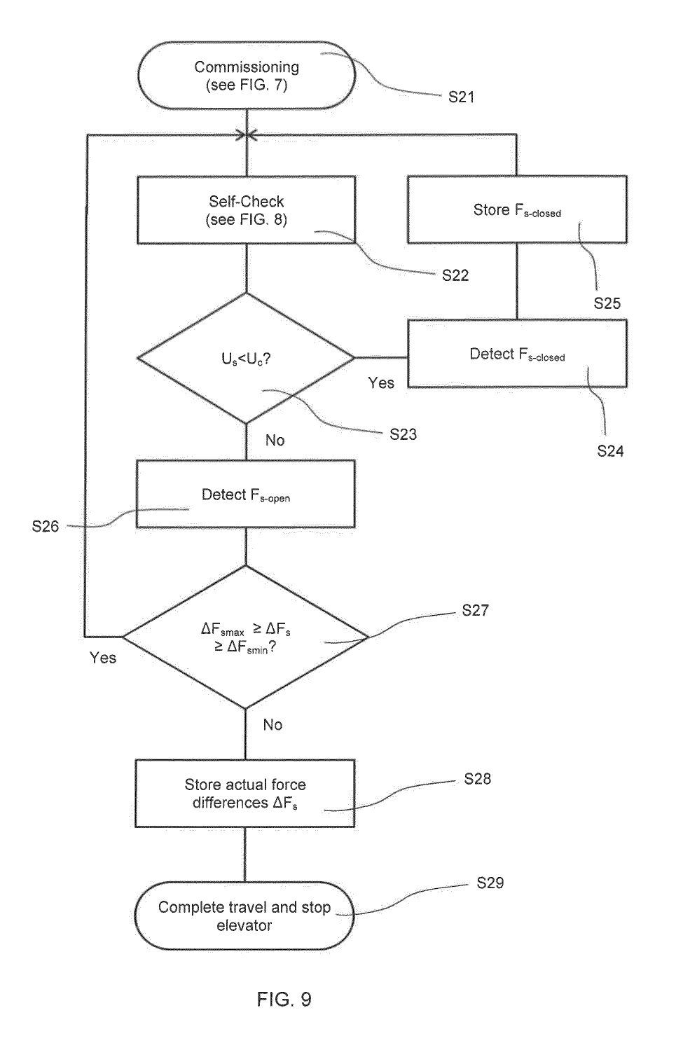

Commissioning of the brake force monitor 46 is outlined in the flowchart of FIG. 7. With the force sensors 42 mounted between the spring retainers 18 and the associated nuts 36 as illustrated in FIGS. 5 and 6, the first step S1 in commissioning is to manually adjust or readjust the brake 1 by means of the adjustment nut 36 in accordance with the brake manufacturer's original instructions. Once completed for both brake arms 10, the brake 1 is closed in step S2. Next the commissioning engineer presses the push-button 52 on the monitor 46 in step S3 and the monitor 46 then automatically records and stores the closed spring forces F_{s1-closed} and F_{s2-closed} obtained from the force sensors 42 for both of the brake springs 16, respectively, in step S4.

In step S5, the electromagnetic actuator 20 is activated or energized to open the brake 1 and in step S6, the final manual step of the commissioning process, the engineer once again presses the push-button 52 and the monitor 46 then automatically records the open spring forces Fₛ₁₋ₒₚₑₙ and Fₛ₂₋ₒₚₑₙ obtained from the force sensors 42 for both of the brake springs 16, respectively, in step S7. After this the manual commissioning process ends at step S8.

Internally, in step S9, the monitor 46 will calculate the force difference ΔFₛ between the actual open and closed spring forces for each spring 16. Accordingly, in this example having two springs 16, the monitor will determine: ΔF₁=Fₛ₁₋ₒₚₑₙ−F_{s1-closed} for the first spring; and ΔF₂=Fₛ₂₋ₒₚₑₙ−F_{s2-closed} for the second spring.

In the next step, S10, the monitor calculates and stores in its internal electronic storage 50 values for the minimum permissible force differential ΔF₁ₘᵢₙ and ΔF₂ₘᵢₙ for each of the springs 16, respectively, by applying a multiplier or gain A to each of the actual force differences ΔF determined in step S9. The gain A is less than one and preferably less than 0.75. In use, as described further with reference to FIG. 9, the monitor 46 will continually compare actual measured force differences ΔF₁ and ΔF₂ with these stored minimum permissible force differentials ΔF₁ₘᵢₙ and ΔF₂ₘᵢₙ to determine whether there is a brake fault, for example, whether the brake 1 is dragging.

Furthermore, the monitor 46 can be used to calculate and store values for the maximum permissible force differential ΔF₁ₘₐₓ and ΔF₂ₘₐₓ for each of the springs 16, respectively, by applying a multiplier or gain B to each of the actual force differences ΔF determined in step S9. The gain B is greater than one but preferably less than 1.1. These stored values can be used subsequently to determine additional brake faults such as, for example, that the brake lining 12 has worn excessively.

After the process of commissioning has been completed the monitor 46 performs a self-check procedure as illustrated in FIG. 8. The first step S11 of the self-check procedure is a determination as to whether the monitor 46 is being supplied with electricity from the power supply 62. If it is not, the first of the LEDs L1 is unlit, the safety chain 66 shall remain open in step S12 and the process will continuously loop around to the decision in step S11 until the affirmative outcome is achieved. At which point the first LED L1 will be illuminated green and in step S13 the monitor 46 will close the safety chain 66.

Next, the monitor 46 will check in step S14 whether the voltage sensor 44 is functioning correctly. This may be achieved by ensuring that a signal Uₛ is being received from the voltage sensor 44. If not, the safety chain 66 is opened in S15 and the first LED L1 is illuminated orange (indicating a defect with the brake force monitoring kit 40). Otherwise, the process proceeds to step S16.

In step S16, the monitor 46 determines whether the force sensors 42 are functioning accurately. If the force sensors 42 are not functioning, as before, the first LED L1 is illuminated orange and a further determination is made as to whether the elevator is in travel, S17. The brake is open, and thereby the elevator is in travel, if the actual voltage signal Uₛ from the voltage sensor 44 is greater than the preset maximum closing voltage U_{c}.

If the elevator is not in travel at step S17, the monitor opens the safety chain 66 immediately in step S18. Otherwise, in step S19 the safety chain 66 is opened only after the elevator has completed its travel. Travel is completed when the brake 1 next closes which is detected when the actual voltage signal Uₛ from the voltage sensor 44 is less than the preset maximum closing voltage U_{c}.

If the voltage sensor 44 and the force sensors 42 are functioning, as determined in step S14 and in step S16, the monitor 46 and all of its components are assessed to be functioning correctly, LED L1 will be illuminated green and the self-check procedure ends in step S20.

FIG. 9 illustrates the overall monitoring process conducted by the brake force monitor 46 including the initial commissioning procedure, step S21, as previously described with reference to FIG. 7 and the subsequent self-check procedure, step S22, outlined in FIG. 8. Following on from the self-check procedure, in step S23 the monitor 46 compares the signal Uₛ received from the voltage sensor 44 with a preset value U_{c}.

In step S23, if the actual voltage signal Uₛ is less than the preset maximum closing voltage U_{c}, the monitor 46 deems that the brake 1 is closed. It subsequently detects and stores the values representative of the current closed spring forces F_{s1-closed} and F_{s2-closed} obtained from the force sensors 42 for both of the brake springs 16, respectively, in step S24 and step S25. The procedure continuously loops through steps S22, S23, S24 and S25 until the actual voltage signal Uₛ as detected by the voltage sensor 44, is greater than the preset maximum closing voltage U_{c}. At this stage the monitor 46 deems that the brake 1 is open and the procedure continues to step S26 where values representative of the actual open spring forces Fₛ₁₋ₒₚₑₙ and Fₛ₂₋ₒₚₑₙ are obtained from the force sensors 42 for both of the brake springs 16, respectively. Using these values and the latest closed spring forces F_{s1-closed} and F_{s2-closed} stored in step S25, the monitor 46 in step S27 calculates the actual force difference ΔFₛ=Fₛ₋ₒₚₑₙ−F_{s-closed} for each spring 16 and determines whether this actual force difference ΔFₘᵢₙ falls within the range defined by the minimum permissible force differential ΔFₘᵢₙ and the maximum permissible force differential ΔFₘₐₓ previously stored in commissioning step S10 for each individual spring 16. If so, the monitor 46 concludes that the brake 1 is functioning correctly and the procedure loops back to the self-check, step S22.

If the actual force difference ΔFₛ lies outside of the permissible range (ΔFₘᵢₙ to ΔFₘₐₓ), the monitor 46 concludes that the brake 1 is defective, the second LED L2 is illuminated red (indicating a brake defect), and, in step S28, a value representing the percentage that the actual force difference ΔFₛ is relative to minimum permissible force differential ΔFₘᵢₙ is stored in storage 50. This value can be subsequently accessed by or displayed to a maintenance technician to enable him to gauge the nature of the brake defect.

In Step S29, the elevator completes its travel and once the monitor 46 judges that the brake 1 has been applied at the end of the travel, as in step S23 when Uₛ<C_{c}, the monitor 46 can provide a signal Sₒᵤₜ to take the elevator out of operation by opening a safety relay 68 within the safety chain 66.

Although herein before described in association with an electromagnetic brake actuator 20, it will be appreciated that the method and apparatus 40 for monitoring the brake spring force Fₛ can be applied to other brake actuators. Furthermore, the method and apparatus can be used not only to monitor multiple brake springs but also a single brake spring.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for monitoring an elevator drive brake comprising the steps of:
detecting a spring force when the brake is closed;
detecting a spring force when the brake is open;
determining a difference between the two detected spring forces; and
comparing the difference between the two detected spring forces with at least one preset permissible force differential to determine whether the brake is defective.

17. The method according to claim 16 wherein the preset permissible force differential is a minimum force differential and the brake is determined to be defective if the difference between the two detected spring forces is less than or equal to the minimum force differential.

18. The method according to claim 16 wherein the preset permissible force differential is a maximum force differential and the brake is determined to be defective if the difference between the two detected spring forces is greater than or equal to maximum force differential.

19. The method according to claim 16 including opening an elevator safety chain of the elevator if the brake is determined to be defective.

20. The method according to claim 19 wherein the safety chain is opened only after the elevator has completed a current travel.

21. The method according to claim 16 including storing the detected spring force every time the brake is closed.

22. The method according to claim 16 including detecting energization of a brake actuator of the brake to determine whether the brake is open or closed.

23. The method according to claim 22 including detecting a voltage supplied to the brake actuator to determine whether the brake is open or closed.

24. The method according to claim 16 including storing the difference between the two detected spring forces if the brake is determined to be defective.

25. The method according to claim 16 further comprising a commissioning step including:
adjusting the brake;
closing the brake;
detecting and storing a closed spring force;
opening the brake;
recording an open spring force;
determining a difference between the open spring force and the closed spring force; and
calculating and storing the at least one preset permissible force differential from the determined difference between the open spring force and the closed spring force.

26. The method according to claim 16 further comprising a self-check step including determining whether power is available, determining whether a voltage sensor is functioning, and opening an elevator safety circuit of an elevator associated with the brake if either power is not available or the voltage sensor is not functioning.

27. The method according to claim 26 further including determining whether force sensors are functioning, determining whether the elevator is in travel, and opening the elevator safety circuit if the force sensors are not functioning and the elevator is not in travel.

28. A brake force monitor for an elevator drive brake comprising:
a force sensor associated with a brake spring of the brake to be monitored; and
an electronic monitor storing at least one preset permissible force differential and, during operation of the brake, comparing the at least one preset permissible force differential with an actual force difference between an open spring force and a closed spring force as detected by the force sensor.

29. The brake force monitor according to claim 28 including a sensor connected to the electronic monitor to detect energization of a brake actuator of the brake.

30. An elevator installation including a motor, a brake for stopping and holding the motor, at least one spring biasing the brake into a closed position, and a brake force monitor comprising:
a force sensor associated with the at least one spring; and
an electronic monitor storing at least one preset permissible force differential and, during operation of the brake, comparing the at least one preset permissible force differential with an actual force difference between an open spring force and a closed spring force as detected by the force sensor.
